(19) United States
(12) Patent Application Publication
(10) Pub. No.: US 2022/0255635 A1
(43) Pub. Date: Aug. 11, 2022

(54) STRUCTURE AND A PROCESSING METHOD OF SYSTEM WITH MULTI-BEAM AND MICRO-BEAMFORMING

(71) Applicant: Aco Healthcare Co., Ltd., Hsinchu (TW)

(72) Inventors: Jian-Hung LIU, Hsinchu (TW); Fu-Yen KUO, Hsinchu (TW); Tang-Chen CHANG, Hsinchu (TW)

(21) Appl. No.: 17/172,405

(22) Filed: Feb. 10, 2021

(51) Int. Cl. H04B 11/00

(52) U.S. Cl. CPC H04B 11/00

(57) ABSTRACT

The ultrasonic system of the present invention uses a microwave beamforming architecture, which can disassemble the multi-channel delay circuit into two circuits of fine delay and coarse delay. Through multi-stage input signal delay and summation, the signal at the probe end can be effectively reduced. The amount of data and hardware complexity meets the needs of system miniaturization. Moreover, the present invention only uses a single microwave beamformer to realize the fine delay calculation of beamforming, and cooperates with the multi-line coarse delay beamforming operation to meet the requirements of multi-line imaging; the setting values of fine delay and coarse delay are also compensated and correction to maintain the accuracy required for multi-line beam focusing on the delay time of each channel.

### BACKGROUND OF THE INVENTION

### Field of the Invention

The present invention relates to a system architecture and processing method with multi-beam and micro-beamforming, and especially refers to: a fine delay with a single beamforming for delay focusing and signal summation, combined with multi-line coarse delay beam focusing technology for delay time compensation and correction.

### Description of the Related Art

Previously related to the multi-beamformer of the present invention, for example, the ultrasonic transducer probe with a micro-beamformer used for multi-line imaging in the US2015/02971.83A1/CN104903741B patent, in this patent, such as the architecture in FIG. 1 couples the channel signals used by individual scan lines in multi-line imaging to different summary nodes through the patch switch controller to perform beamformer operations.

### BRIEF SUMMARY OF THE INVENTION

The problem to be solved by the present invention is that in order to improve the frame rate of image scanning, the system design mostly adopts the multi-beam imaging method. Therefore, it is necessary to add several sets of micro-beamformers, to achieve parallel processing of multi-line imaging. Although the frame rate can be increased as a result, it also increases the complexity of the hardware relatively, making it difficult to achieve miniaturization of the hardware.

The present invention means to solve the technical problem of the system is to propose for each parameter an optimum engagement range, and to propose the most suitable parameter combination through the ultrasonic system, and use the micro-beamforming architecture to the delay of the multi-channel that the circuit is disassembled into a fine delay circuit and a coarse delay circuit, through multi-stage input signal delay and summation, the signal data volume and hardware complexity at the probe end can be effectively reduced, meet the needs of system miniaturization, and avoid large beamforming errors or high calculations outside the combination of parameters the amount. On the other hand, to increase the frame rate of image scanning, this system design mostly adopts multi-beam imaging. The idea is to combine multi-beam and micro-beamforming system architecture is optimized for complexity.

There is no need to use multiple sets of micro-beamformers, only a single micro-beamformer is needed to achieve the fine delay of beamforming. Delay operation combined with multi-line coarse delay beamforming operation to meet the requirements of multi-beam imaging, and in response to this architecture, fine delay and coarse delay is compensated and corrected to maintain the accuracy required for the multi-line beam focusing on the delay time of each channel.

The effect of the present invention compared with the prior art is to increase the frame rate of image scanning. When the system design adopts the multi-beam imaging method, there is no need to add several sets of micro-beamformer, only by adjusting the common fine delay and assigning the delay time setting the value of the coarse delay of each scan line, you can make the equivalent delay focus time of each scan line very it is close to the ideal beam focusing delay time, which can be effectively applied to ultrasonic scanners.

### BRIEF DESCRIPTION OF THE DRAWINGS

FIG. 1 is a drawing illustrating prior art architecture.

FIG. 2 is a drawing illustrating multi-channel signal delay and summing operations on different scan depths of the present invention.

FIG. 3 is a drawing illustrating delay of the coarse delay profile of the present invention.

FIG. 4 is a drawing illustrating single beam, dual beam, and quad beam frame rate of the present invention.

FIG. 5 is a drawing illustrating single beam and dual beam delay profile of the present invention.

FIG. 6 is a drawing illustrating multi-beamforming system architecture of a micro-beamformer.

FIG. 7 is a drawing illustrating architecture of single beamforming with fine delay focusing and signal summation, combined with multi-beam coarse delay beam focusing.

FIG. 8 is a drawing illustrating a single beam process and the result of the operation of single beam fine delay.

FIG. 9 is a drawing illustrating fine and coarse delay through the delay compensation and the equivalent delay time.

FIG. 10 is a drawing illustrating a simple computing paradigm optimal delay setting.

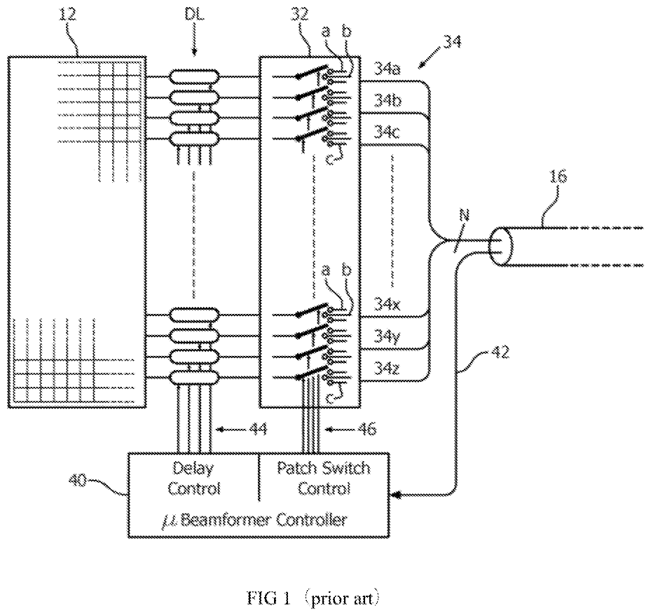

### DETAILED DESCRIPTION OF THE INVENTION

According to the present invention, an optimal micro-beamforming architectures of a multi-beamformer system is detailed as follows.

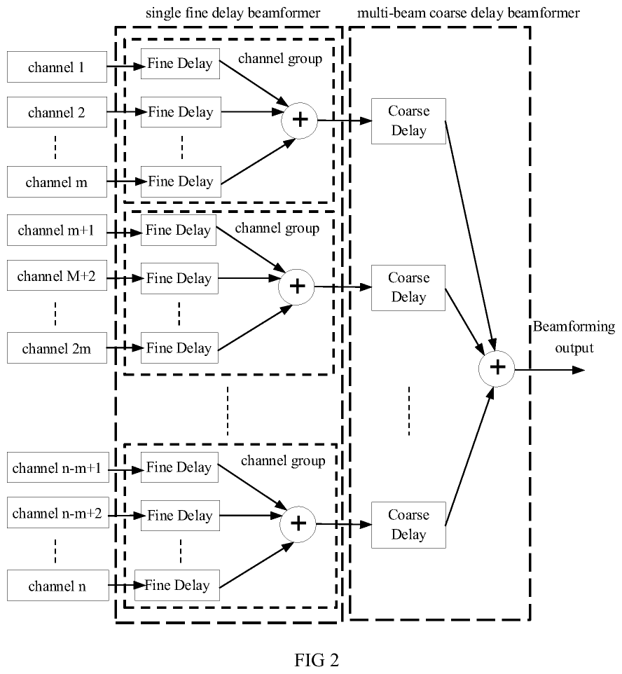

Micro-beamforming is to perform multi-channel signal delay and summation operations at different scanning depths to achieve the purpose of focusing imaging. Its architecture is shown in FIG. 2. The input channels are divided into several channel groups, and the delay of each channel required for focusing is disassembled into two parts of fine delay and coarse delay. Each group will first perform a small range of fine delay focus delay and signal summation to effectively reduce the number of channels, then, the summed signals of each group are subjected to a large-range coarse delay focus delay and summation to complete the calculation of the focus delay and signal summation required for beam focusing on each channel.

Coarse delay is held between the common channel group, and the fine delay for the channel group delay time difference of each channel, which can be expressed as follows:

CoarseDelay(k)<min {BeamformDelay(n)|channel n inside channel group k}

FineDelay(n)=BeamformDelay(n)-CoarseDelay(k)

Where k is the group number, n is the channel number, and BeamFormDelay(n) is the ideal beam focus delay time.

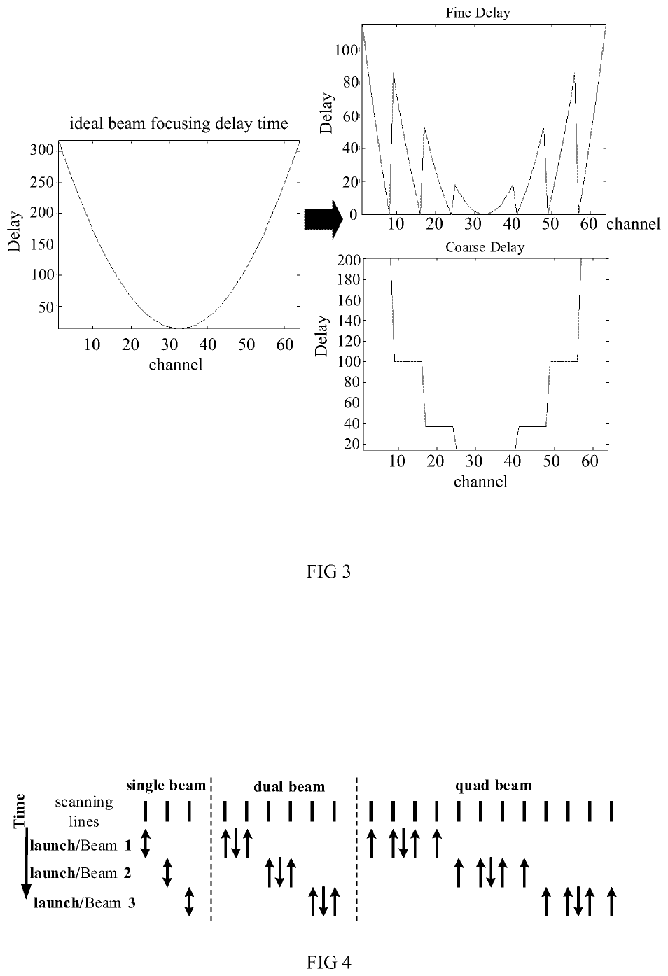

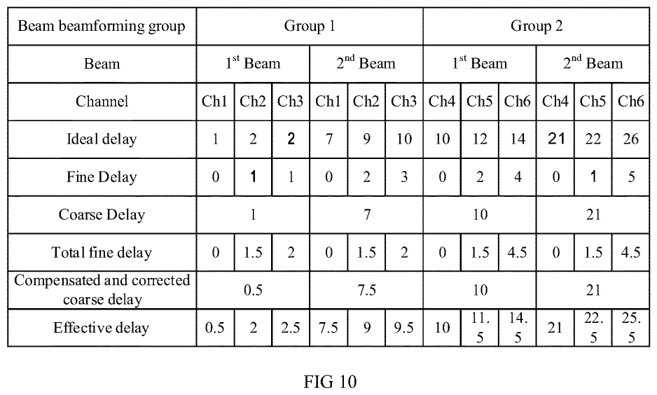

Refer to the simple calculation example in FIG. 10; and the delay distribution example as shown in FIG. 3.

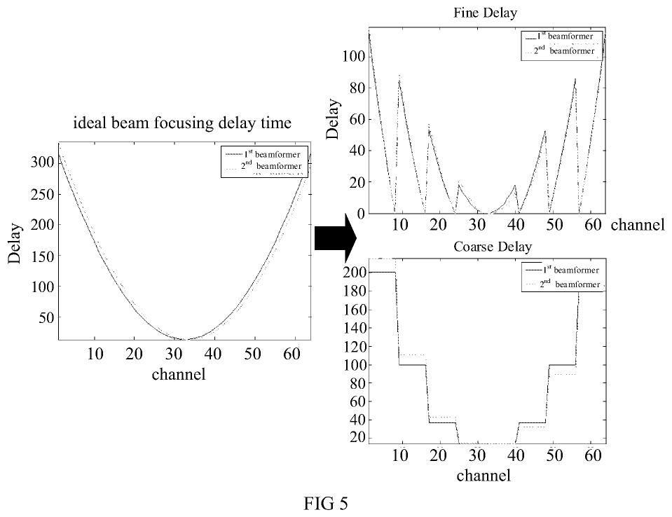

In addition, in order to increase the frame rate of scanned images, multi-line imaging is generally used for beam focusing processing. The method is to perform beam focusing processing of multiple scan lines at the same time after a single beam is launched. Therefore, the different processing methods such as single beam, dual beam, and quad beam as shown in the example in FIG. 4 will show multiple levels of difference in the acquisition rate of the image display.

The dual beam focus of the delay profile is illustrated in the example shown in FIG. 5

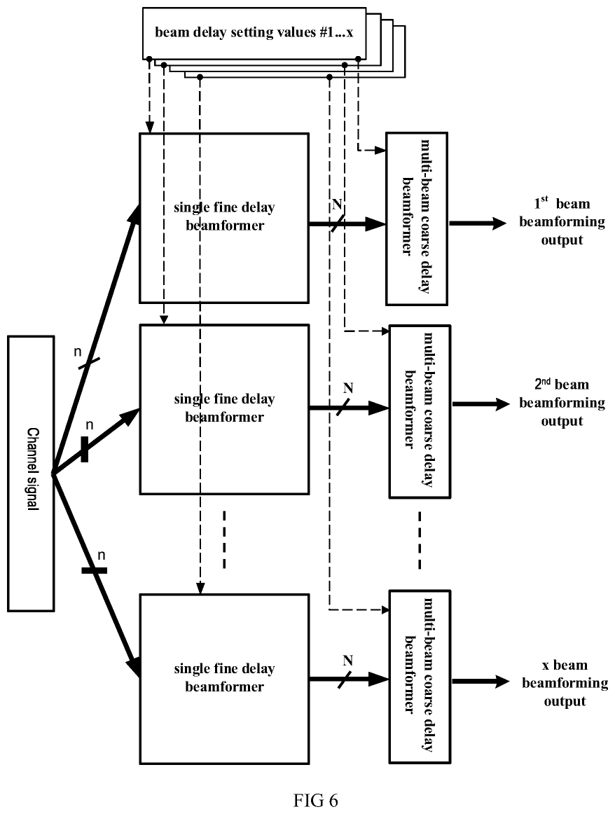

In the system architecture, two sets of fine delay and coarse delay focus delay calculations need to be performed simultaneously. Under the quad beam architecture, the system needs to perform four sets of fine delay and coarse delay focus delay processing at the same time. FIG. 6 shows the system architecture combining multi-beam beamformer and micro-beamforming. although this architecture can greatly increase the frame rate of the scanned image, it also greatly increases the system complexity, making it difficult to achieve miniaturization of the hardware size.

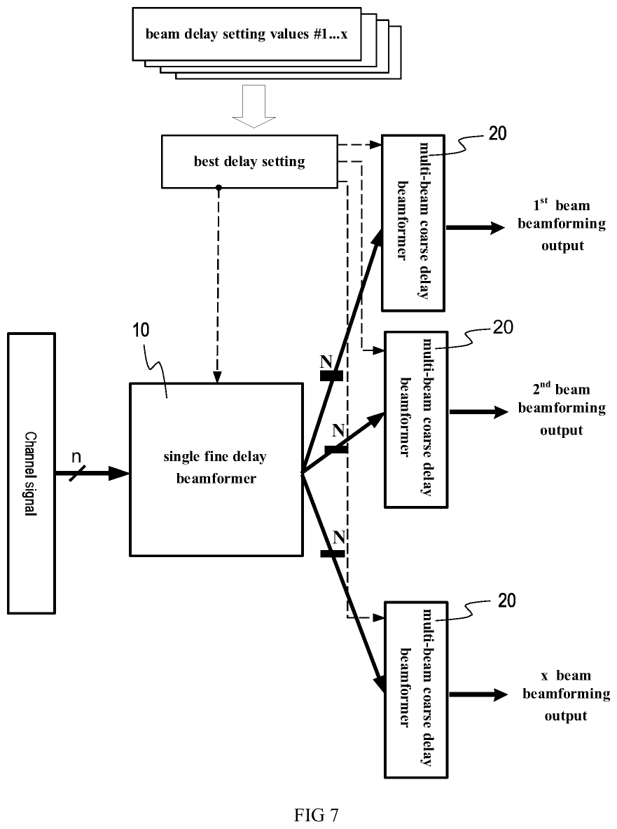

In order to optimize the complexity of system implementation and achieve a miniaturized design, single fine delay beamforming (10) and multi-line coarse delay beamforming (20) can be used to achieve. In the present invention, the delay focusing and signal summation of fine delay using single beamforming are combined with the compensation and correction of the delay time in the multi-line coarse delay beam focusing. The architecture is shown in FIG. 7.

The fine delay beam focusing using a single beam reduces the complexity of the multi-line beamforming system architecture, but in order to reduce the overall beamforming focus delay error, the calculation method of the fine delay beam delay time of the common single beam is as follows:

CommonFineDelay(n)=mean{FineDelay_{Beam_1}(n),

FineDelay_{Beam_2}(n), FineDelay_{Beam_x}(n)}

Among these Beam_x is the x-th beam, and CommonFineDelay(n) is the beam delay time of the fine delay of a common single beam .

Among them, the common single beam fine delay beam delay time calculation method can also use the linear or non-linear function calculation f(⋅) of the fine delay of each beam, and meet the following:

CommonFineDelay(n)=f(FineDelay_{Beam_1}(n),

FineDelay_{Beam_2}(n), FineDelay_{Beam_ x}(n)),

where min (FineDelay_{Beam_1}(n), FineDelay_{Beam_2}(n), . . . , FineDelay_{Beam_x}(n))≤f(⋅)≤max (FineDelay_{Beam_1}(n), FineDelay_{Beam_2}(n), . . . , FineDelay_{Beam_x}(n));

Among these, Beam_x is the x-th beam, and CommonFineDelay(n) is the beam delay time of the fine delay of a common single beam.

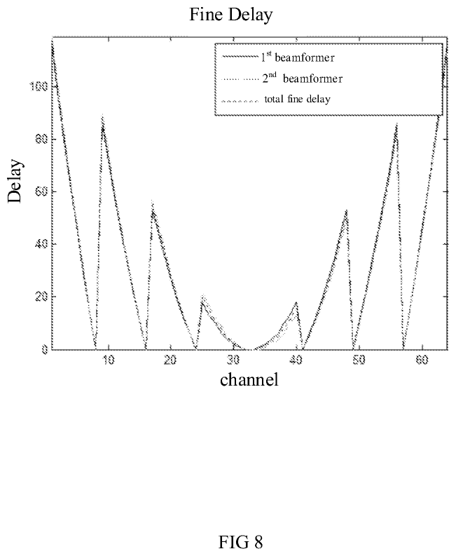

Shown in the example of FIG. 8, single beam and dual beam processing and a single beam fine delay time calculation result.

The focus delay time of the coarse delay of each scan line is compensated and corrected by referring to the common fine delay in the following way:

$$M {eanOfFineDelayError}_{Beam\_x} ( k ) = mean \{ {FineDelay}_{Beam\_x} ( n ) - CommonFineDelay ( n ) \vert channel n inside channel group k \} \\ C {ompensatedCoarseDelay}_{Beam\_x} ( k ) = {CoarseDelay}_{Beam\_x} ( k ) + {MeanOfFineDelayError}_{Beam\_x} ( k )$$

The CompensatedCoarseDelay_{Beam_x}(k) is the beam delay time of the compensated and corrected coarse delay.

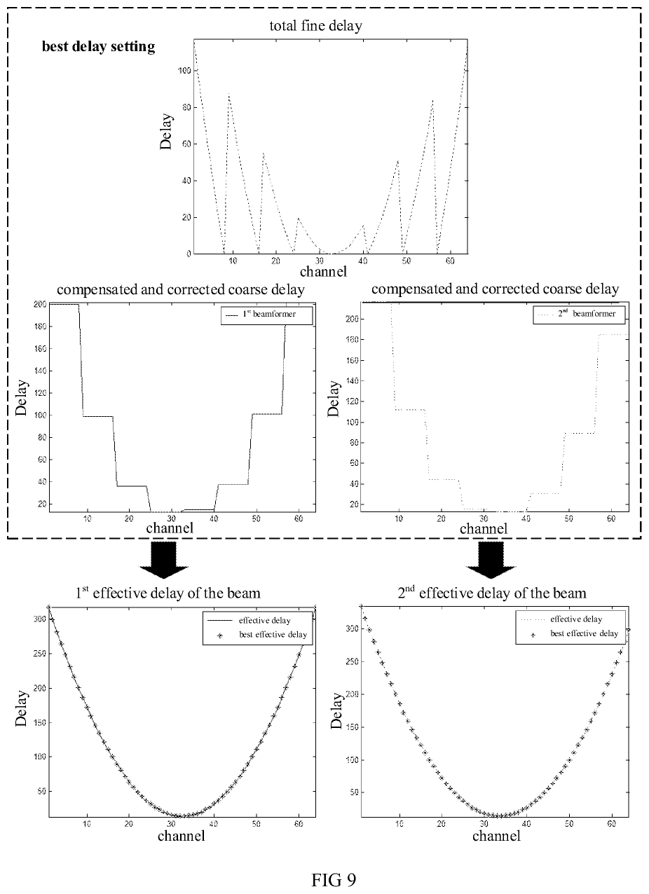

Adjusting the common fine delay and the delay time setting value of the coarse delay assigned to each scan line according to the above method, then can make the equivalent delayed focus time of each scan line very close to the ideal beam focus delay time, as shown in FIG. 9 for dual in the beam embodiment, the common fine delay and the compensated coarse delay produced by it, and the comparison of its relatively equivalent focus delay time with the ideal focus delay time.

FIG. 10 is a simple calculation example of optimized delay setting. The CommonFineDelay(n) and the CompensatedCoarseDelay_{Beam_x}(k) are added to obtain the effective delay time of the beam focusing.

Shown in FIG. 7, which includes multi-beams with a micro-beamforming system architecture, where the system is that it has the best fit suitable for computational complexity and precision registration of the required system as comprising N=8˜32 channel groups, and each channel group comprising m =8 channels, which the system altogether is n=8*N-th channels with X=2˜8 beams

The above only expresses the embodiments of the present invention, but does not limit the scope of the patent of the present invention. For those of ordinary skill in the art, several modifications can be made without departing from the scope of the present invention. And any improvements all belong to the protection scope of the present invention.

1. A processing method for a multi-beam and micro-beamforming system which uses a single micro-beamformer to achieve a fine delay beamforming operation, combined with a multi-beam coarse delay beamforming operation to achieve the purpose of multi-beam imaging, which uses single beamforming fine delay focusing and signal summation achieved with compensation and correction of delay time in beam focusing of multi-beam coarse delay; the micro-beamformer includes a use of a delay circuit for multiple channels at different scanning depths, signal delay focusing, and signal summation processing, where coarse delay is common group delay duration in the channel group, and fine delay is delay difference time of each channel in the channel group, the method utilizing, a CoarseDelay(k) that is less than or equal to a value found by:
CoarseDelay(k)≤min{BeamformDelay(n)|channel n inside channel group k};
FineDelay(n)=BeamformDelay(n)-CoarseDelay(k);
wherein k is group ID, n is channel number, and BeamformDelay(n) is beam focusing delay time, single beam fine delay time calculating employs fine delay of linear or non-linear function operation f(⋅), and meets the following conditions:
$$CommonFineDelay ( n ) = f ( {FineDelay}_{Beam\_ 1} ( n ) , {FineDelay}_{Beam\_ 2} ( n ) , … , {FineDelay}_{Beam\_x} ( n ) ) , where min ( {FineDelay}_{Beam\_ 1} ( n ) , {FineDelay}_{Beam\_ 2} ( n ) , … , {FineDelay}_{Beam\_x} ( n - ) ) \leq f ( . ) \leq max ( {FineDelay}_{Beam\_ 1} ( n ) , {FineDelay}_{Beam\_ 2} ( n ) , … , {FineDelay}_{Beam\_x} ( - n ) ) - ;$$
wherein, Beam_x is an x-th beam,
and CommonFineDelay(n) is beam delay time of the fine delay of a common single beam.

2. The processing method for the multi-beam and micro-beamforming system of claim 1, wherein the micro-beamformer of different scans by the delay depth are summed with the signal processing delay focusing circuit of multi-channel signal lines comprising:
an input area divided into a plurality of channel groups, each channel and focusing delay disassembled into a fine delay and a coarse delay, where each group first performs a small range of fine delay and signal summation, and then performs a large range of coarse delay on the summed signal of each group and focus delay and summation to complete the calculation processing of the focus delay and signal summation required for beam focusing on each channel.

3. The processing method for the multi-beam and micro-beamforming system of claim 1, further comprising:
$$CommonFineDelay ( n ) = mean \{ {FineDelay}_{Beam\_ 1} ( n ) , {FineDelay}_{Beam\_ 2} ( n ) , … … , {FineDelay}_{Beam\_x} ( n ) \}$$
$$M - {eanOfFineDelayError}_{Beam\_x} ( k ) = mean \{ {FineDelay}_{Beam\_x} ( n ) - CommonFineDelay ( n ) \vert channel n inside channel group k \} ;$$
$$C - {ompensatedCoarseDelay}_{Beam\_x} ( k ) = {CoarseDelay}_{Beam\_x} ( k ) + {MeanOfFineDelayError}_{Beam\_x} ( k ) ;$$
wherein Beam_x is the x-th beam, CommonFineDelay(n) is the beam delay time of the fine delay of a common single beam,
and CompensatedCoarseDelay_{Beam_x}(k) is the coarse delay after compensation and correction.

4. The processing method for the multi-beam and micro-beamforming system of claim 3, wherein the CommonFineDelay(n) and the CompensatedCoarseDelay_{Beam_x}(k) are added to get an effective delay time of the beam focusing.

5. A multi-beam and micro-beamforming system of claim 1, wherein suitable computational complexity and precision requirements are based as comprising N=8˜32 channel groups, and each channel group comprises m =8 channels, and n=8*N th channels with X=2˜8 multi-beam beamformers.
